(19) United States
(12) Patent Application Publication
(10) Pub. No.: US 2020/0233255 A1
(43) Pub. Date: Jul. 23, 2020

(54) DISPLAY DEVICE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: HUI-CHENG LIN, New Taipei (TW); CHIA-HUANG CHANG, New Taipei (TW)

(21) Appl. No.: 16/275,950

(22) Filed: Feb. 14, 2019

(30) Foreign Application Priority Data
Jan. 21, 2019 (CN) 201910054091.X

(51) Int. Cl. G02F 1/1333; G02F 1/1335

(52) U.S. Cl. CPC G02F 1/133308; G02F 1/133504; G02F 2202/28; G02F 2001/133314; G02F 1/133603; G02F 2001/13332

(57) ABSTRACT

A display device includes a liquid crystal display (LCD) panel, a diffusion film, and an adhesive frame. The adhesive frame is arranged between the LCD panel and the diffusion film. The diffusion film is configured to diffuse incident light incident on the diffusion film. The adhesive frame includes a first surface and an opposite second surface. The first surface of the adhesive frame is coupled to a periphery of the LCD panel. The second surface of the adhesive frame is coupled to a periphery of the diffusion film.

### FIELD

The subject matter herein generally relates to a display device.

### BACKGROUND

Generally, a liquid crystal display (LCD) device includes an LCD panel and a backlight module. The backlight module is further categorized as a direct-type backlight module or a side-type backlight module according to different positions of a light source. As shown in FIG. 1, the LCD device 10 of a prior art direct-type backlight module includes a plurality of light emitting diodes (LED) light sources 11 (only one is shown), a backplane 12, a front frame 13, a liquid crystal display panel 14, a middle frame 15, an optical film set 16, and a diffusion plate 17. The front frame 13 and the backplane 12 cooperatively form a receiving cavity, and the middle frame 15, the LCD panel 14, the optical film set 16, and the diffusion plate 17 are received therein. The LCD panel 14 is located between the middle frame 15 and the front frame 13 and is supported by the middle frame 15. The LED light source 11 is disposed on a base plate 12a of the backplane 12 directly under the LCD panel 14. The optical film group 16 and the diffusion plate 17 are disposed between the LCD panel 14 and the LED light source 11, wherein the optical film group 16 is closer to the LCD panel 14. A main function of the diffusion plate 17 is to diffuse the light emitted from the LED light source 11, thereby improving uniformity of the light emitted from the diffusion plate 17. The display device 10 needs to reserve a large space in the receiving cavity for receiving the middle frame 15, and the thickness of the diffusion plate 17 is generally between 1.0 and 3.0 mm.

### BRIEF DESCRIPTION OF THE DRAWINGS

Implementations of the present disclosure will now be described, by way of embodiments, with reference to the attached figures.

FIG. 1 is a cross-sectional view of a liquid crystal display (LCD) device of a prior art direct-type backlight module.

FIG. 2 is a cross-sectional view of an embodiment of an LCD device.

FIG. 3 is a diagram of an embodiment of an adhesive frame surrounding an optical film group.

FIG. 4 is similar to FIG. 3, but showing another embodiment of an adhesive frame surrounding the optical film group.

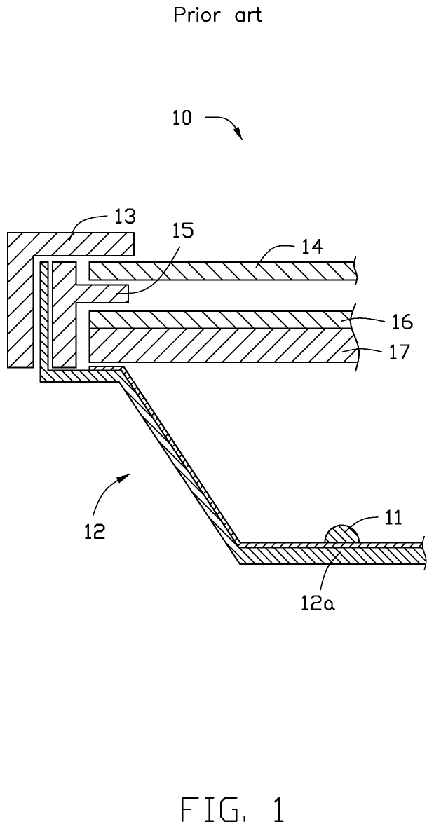

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

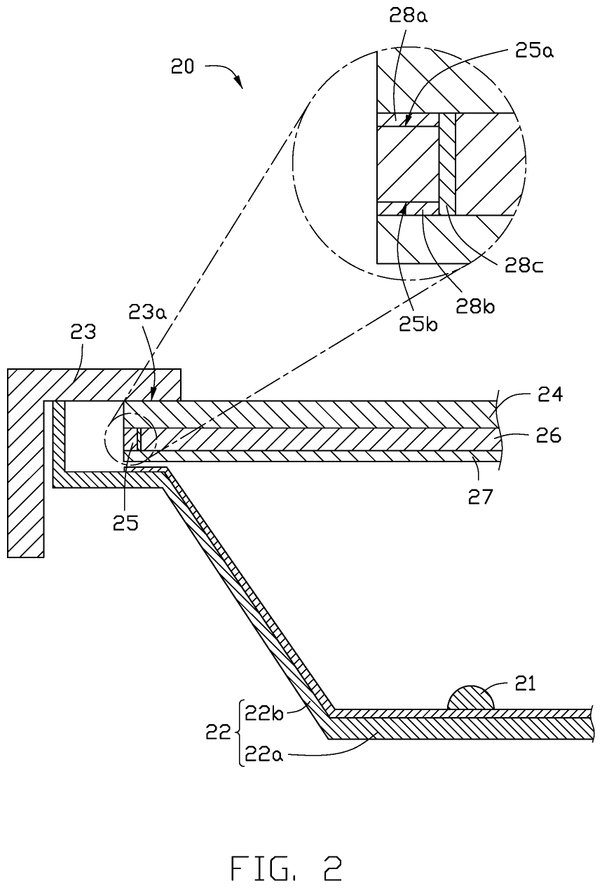

Referring to FIG. 2, a display device 20 includes a front frame 23, a liquid crystal display (LCD) panel 24, a diffusion film 27, and an adhesive frame 25. The diffusion film 27 is configured to diffuse incident light on the diffusion film 27. The adhesive frame 25 is arranged between the LCD panel 24 and the diffusion film 27 and includes a first surface 25a and an opposite second surface 25b. The first surface 25a is coupled to a periphery of the LCD panel 24, and the second surface 25b is coupled to a periphery of the diffusion film 27. The adhesive frame 25 is completely under the periphery of the LCD panel 24, so that the adhesive frame 25 is not required to be accommodated in a designated space within the display device 20 as required in the prior art, thereby saving manufacturing costs. The front frame 23 is mounted to a periphery of a side of the LCD panel 24 facing away from the adhesive frame 25.

In one embodiment, the diffusion film 27 is a diffusion film having a haze of 90% to 99% and a transmittance of 40% to 60%. A thickness of the diffusion film 27 is 0.1 to 0.5 mm. In other embodiments, the thickness, the haze, and the transmittance of the diffusion film 27 can be adjusted according to actual conditions. Optical diffusion of the diffusion film 27 is achieved by the haze and transmittance of the diffusion film 27. The higher the haze, the better an optical diffusion effect, and the higher the transmittance, the less loss of light energy. Previous experiments have shown that a desired optical diffusion effect is achieved by setting the haze between 90% and 99% while maintaining a transmittance of 40% to 60%. The diffusion film 27 has a reduced thickness in a direction perpendicular to the LCD panel 24 and a lighter weight.

The LCD panel 24 may be a Thin Film Transistor-Liquid Crystal Display (TFT-LCD), which may include sequentially arranged from top to bottom an upper polarizer, a color film substrate (also referred to as a counter electrode substrate), a liquid crystal layer, an array substrate, and a lower polarizer. In other embodiments, the LCD panel 24 may be other structures, which are well known to those skilled in the art and will not be described herein.

As shown in FIG. 2, the first surface 25a of the adhesive frame 25 is adhered to the LCD panel 24 by a colloid 28a, and the second surface 25b is adhered to the diffusion film 27 by a colloid 28b. In one embodiment, the colloid 28a and the colloid 28b are at least one of pressure sensitive glue, water glue, and ultraviolet glue. The adhesive frame 25 may be a foam acrylic, such as polymethyl methacrylate (PMMA) or polyethylene terephthalate (PET). The adhesive frame 25 may also be a foam, such as polyurethane (PU) or polyethylene (PE). The display device 20 further includes an optical film set 26 arranged between the LCD panel 24 and the diffusion film 27. The optical film set 26 includes at least one optical film. The at least one optical film may include at least one of a prism film, a diffusion film, a microprism film, a brightness enhancement film, a reflection film, or a combination thereof, and other optical films may be used.

In one embodiment, the optical film set 26 is received in an accommodating space surrounded by the adhesive frame 25. The optical film set 26 is substantially parallel to the LCD panel 24. The optical film set 26 is limited by the diffusion film 27, the LCD panel 24, and the adhesive frame 25 to only move in a direction parallel to the LCD panel 24 and not perpendicular to the LCD panel 24, thereby achieving a partial fixing effect of the optical film group 26.

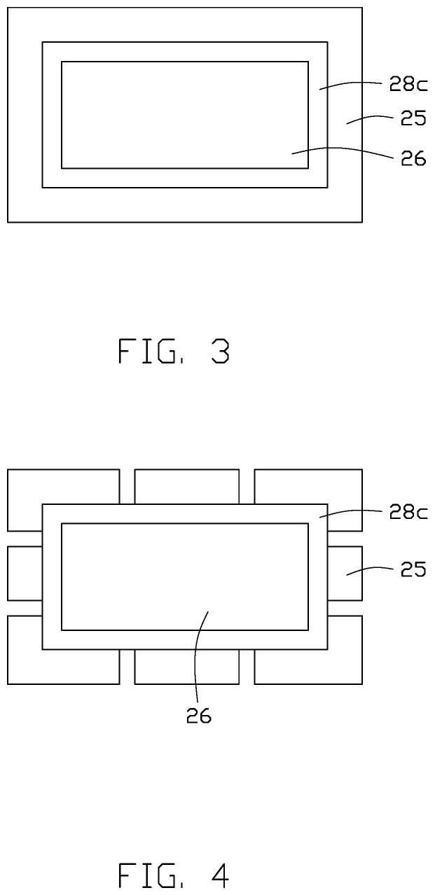

FIGS. 3 and 4 show different embodiments of the adhesive frame 25. In both embodiments, the optical film set 26 and the adhesive frame 25 are adhered together and reinforced by a colloid 28c to limit movement of the optical film set 26. The colloid 28c is at least one of a pressure sensitive glue, a water glue, and an ultraviolet glue.

Referring to FIG. 3, the adhesive frame 25 continuously surrounds the optical film set 26. Referring to FIG. 4, in another embodiment, the adhesive frame 25 discontinuously surrounds the optical film set 26.

Referring to FIG. 2 again, the display device 20 further includes a backplane 22 including a base plate 22a and at least one side plate 22b. The base plate 22a is arranged on a side of the diffusion film 27 facing away from the optical film group 26, and the side plate 22b extends from an end of the base plate 22a toward the LCD panel 24 and is fixed to the front frame 23 to form a receiving space (not shown). The LCD panel 24, the optical film group 26, the adhesive frame 25, and the diffusion film 27 are received in the receiving space. A plurality of backlight sources 21 (only one shown in FIG. 2) are arranged on a surface of the base plate 22a facing the diffusion film 27. The backlight source 21 emits a backlight. The backlight passes sequentially through the diffusion film 27, the optical film group 26, and the LCD panel 24 and then is output as an imaging light through the LCD panel 24. The backlight 21 can be a light emitting diode or a cold cathode. The colors emitted by the backlight sources 21 may be the same or different, and may emit blue light, ultraviolet light, red light, green light, yellow light, white light, or other colors of light.

The above-described display device 20 has a simplified middle frame structure and replaces the middle frame of the prior art with the adhesive frame 25 arranged between the LCD panel 24 and the diffusion film 27, thereby reducing a size and weight of the display device 20 and saving manufacturing costs.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

1. A display device comprising:
a liquid crystal display (LCD) panel;
a diffusion film; and
an adhesive frame arranged between the LCD panel and the diffusion film;
wherein:
the diffusion film is configured to diffuse incident light incident on the diffusion film;
the adhesive frame comprises a first surface and an opposite second surface;
the first surface of the adhesive frame is coupled to a periphery of the LCD panel;
the second surface of the adhesive frame is coupled to a periphery of the diffusion film; and
further comprises an optical film set sandwiched between the LCD panel and the diffusion film and received in an accommodating space surrounded by the adhesive frame, the optical film set is limited by the diffusion film, the LCD panel, and the adhesive frame to only move in a direction parallel to the LCD panel.

2. The display device of claim 1, wherein:
the first surface of the adhesive frame is adhered to the LCD panel by a colloid; and
the second surface of the adhesive frame is adhered to the diffusion film by the colloid.

3. The display device of claim 2 further comprising a front frame mounted to a periphery of a side of the LCD panel facing away from the adhesive frame.

4. The display device of claim 3, wherein the optical film set comprises at least one optical film.

5. The display device of claim 4, wherein the adhesive frame and the optical film set are adhered together by the colloid.

6. The display device of claim 4, wherein the adhesive frame continuously surrounds the optical film set.

7. The display device of claim 4, wherein the adhesive frame discontinuously surrounds the optical film set.

8. The display device of claim 4, wherein the colloid comprises at least one of pressure sensitive glue, water glue, and ultraviolet glue.

9. The display device of claim 4 further comprising a backplane comprising a base plate and at least one side plate, wherein:
the base plate is arranged on a side of the diffusion film facing away from the optical film set; and
the side plate extends from an end of the base plate toward the LCD panel and is fixed to the front frame.

10. The display device of claim 9 further comprising a backlight source arranged on the base plate facing the diffusion film, wherein:
the backlight source is configured to emit a backlight; and
the backlight passes in sequence through the diffusion film, the optical film set, and the LCD panel and then output as an imaging light through the LCD panel.

11. The display device of claim 1, wherein:
the diffusion film comprises a haze of 90% to 99% and a transmittance of 40% to 60%; and
a thickness of the diffusion film is 0.1 mm to 0.5 mm.

12.-14. (canceled)
